(19) United States
(12) Patent Application Publication
(10) Pub. No.: US 2026/0175522 A1
(43) Pub. Date: Jun. 25, 2026

(54) HANDHELD FUSION WELDING SYSTEM

(71) Applicant: Jason A. Lawrence, Owasso, OK (US)

(72) Inventor: Jason A. Lawrence, Owasso, OK (US)

(21) Appl. No.: 19/414,883

(22) Filed: Dec. 10, 2025

Related U.S. Application Data
(60) Provisional application No. 63/737,216, filed on Dec. 20, 2024.

(51) Int. Cl. B29C 65/26; B29C 65/00; B29L 23/00

(52) U.S. Cl. CPC B29C 65/26; B29C 66/5221; B29C 66/861; B29L 2023/22

(57) ABSTRACT

Disclosed is a handheld fusion welding device including a handle; a heating portion attached to the handle with a plurality of channels; an inlet tube residing within the handle and configured to receive a heated fluid from a remote heating unit and provide the heated fluid to the plurality of channels; and an outlet tube residing within the handle and configured to receive the heated fluid from the plurality of channels and return the heated fluid to the remote heating unit. The heating portion comprises a first surface and a second surface opposite the first surface. The first surface is configured to contact and transfer heat to a first component such that a portion of the first component at least partially melts. The second surface is configured to contact and transfer heat to a second component such that a portion of the second component at least partially melts.

### CROSS-REFERENCE TO RELATED APPLICATIONS

This application claims the benefit of U.S. Provisional Patent Application No. 63/737,216 filed on Dec. 20, 2024. The entirety of this application is hereby incorporated herein by reference.

### BACKGROUND OF THE DISCLOSURE

Fusion welding machines for small diameter pipes and tubes are of interest all over the world. However, there are various challenges posed by such fusion welding processes. For example, such fusion welding machines are typically quite large and heavy relative to the pipes and tubes being joined and involve extensive installation complexities. These machines involve cast-in elements, mechanical relays, optically isolated and solid-state relays, and switching large currents for high-powered elements and high surface temperatures. Butt fusion is a process that falls under the umbrella of fusion welding and typically involves clamping pipes to an electrical heating plate that contacts and melts the pipes such that they can be joined together. Butt fusion faces the same obstacles that are generally faced by fusion welding machines.

Additionally, because butt fusion is generally associated with smaller relative scales and sizes of components being joined, the fusion welding work is more precise and control of aspects, such as the misalignment of component profiles, takes on a much greater importance than the supporting moments being applied to the components being joined. Traditional machines do not adequately address these concerns.

Traditional Hydraulic-style fusion welding equipment also faces undesirable issues because of high drag forces (i.e., the frictional resistance of the carriage) due to large or heavy components. The forces they are required to produce for small pipes and tubes are relatively low and traditional equipment must closely regulate low hydraulic pressures to produce the desired joining force. Additionally, friction produced by the equipment, if varying, can introduce significant uncertainty as to the actual joining forces being applied, which is undesirable.

Moreover, joining guidelines for small diameter and thin-wall pipes tend to reference visual indicators of consistency, such as the size of the displaced bead, the evenness around its circumference, and the perceptible offset of the adjacent pipe profiles. Manually operated equipment can also be employed, such as lever-or screw-operated machines. However, shortcomings of these are that joining forces, if measured at all, are measured incidentally or indirectly via means such as torque applied, calculated mechanical advantages, or a load cell which measures reaction pressure at a point in the load path near, but not at, the interface being joined.

Finally, many traditional fusion welding machines involve some level of combustible gas being present on site due to the increased proximity of live or active main gas lines, entailing special measures to be employed, such as manually driving the trimming tools after removing the brushes from the motor, unplugging electrical heating elements and relying on stored heat via thermal mass for the necessary heat inputs. As discussed above, current heating technologies involve switched electrical currents with the temperature measured locally at the heater and either controlled by a device adjacent to the heater or near the welding machine. These switching elements or control circuits must be carefully monitored to reduce the potential for adverse events such as sparking which could potentially initiate an explosion in undesirable conditions.

There is therefore a desire for a fusion welding system with assurances of integrity, greater control of the fusion process, more accurate measurements of the joining forces being applied, and reduced or eliminated potential for initiating an explosion in a gaseous environment. There is also a desire for more economically friendly fusion welding systems, as hydraulically operated equipment that utilizes large industrial electric motors and high powered electrical heating devices can be unnecessarily and prohibitively expensive.

### SUMMARY OF THE INVENTION

According to one aspect of the present disclosure, a handheld fusion welding device can include a handle; a heating portion attached to the handle and comprising a plurality of channels; an inlet tube residing within the handle and configured to receive a heated fluid from a remote heating unit and provide the heated fluid to the plurality of channels; and an outlet tube residing within the handle and configured to receive the heated fluid from the plurality of channels and return the heated fluid to the remote heating unit; wherein the heating portion comprises a first surface and a second surface opposite the first surface; wherein the first surface is configured to contact and transfer heat to a first component such that a portion of the first component at least partially melts; wherein the second surface is configured to contact and transfer heat to a second component such that a portion of the second component at least partially melts; wherein the at least partially melted portions of the first and second components are joined together to create a welded component.

In some embodiments, the heating portion can include a plurality of layers of material and the plurality of channels are formed between the layers of the plurality of layers. In some embodiments, the material can include at least one of glass or laminated glass. In some embodiments, the heating portion can be clamped to the handle. In some embodiments, the handle can include an insulated grip. In some embodiments, the insulated grip can include a wood material. In some embodiments, the heated fluid can include oil. In some embodiments, the heated fluid can include a fluid heated to approximately 450° F. In some embodiments, the inlet tube and outlet tube can include a high temperature silicon rubber material. In some embodiments, the inlet tube and outlet tube can be contained within a containment wall and an abrasion jacket surrounding the containment wall.

According to another aspect of the present disclosure, a fusion welding system can include a remote heating unit configured to heat a fluid and maintain the heated fluid; a handheld fusion welding device; and a pump configured to pump the heated fluid to the handheld fusion device. The handheld fusion welding device can include a handle; a heating portion attached to the handle and comprising a plurality of channels; an inlet tube residing within the handle and configured to receive a heated fluid from a remote heating unit and provide the heated fluid to the plurality of channels; and an outlet tube residing within the handle and configured to receive the heated fluid from the plurality of channels and return the heated fluid to the remote heating unit; wherein the heating portion comprises a first surface and a second surface opposite the first surface; wherein the first surface is configured to contact and transfer heat to a first component such that a portion of the first component at least partially melts; wherein the second surface is configured to contact and transfer heat to a second component such that a portion of the second component at least partially melts; wherein the at least partially melted portions of the first and second components are joined together to create a welded component.

In some embodiments, the heating portion can include a plurality of layers of material and the plurality of channels are formed between the layers of the plurality of layers. In some embodiments, the material can include at least one of glass or laminated glass. In some embodiments, the heating portion can be clamped to the handle. In some embodiments, the handle can include an insulated grip. In some embodiments, the insulated grip can include a wood material. In some embodiments, the heated fluid can include oil. In some embodiments, the heated fluid can include a fluid heated to approximately 450° F. In some embodiments, the inlet tube and outlet tube can include a high temperature silicon rubber material. In some embodiments, the inlet tube and outlet tube can be contained within a containment wall and an abrasion jacket surrounding the containment wall.

### BRIEF DESCRIPTION OF THE FIGURES

FIGS. 1A-1C show a fusion welding system and its various components according to example embodiments of the present disclosure.

FIGS. 2A-2B show an example power pack according to example embodiments of the present disclosure.

FIG. 3 is a process for operating a fusion welding system according to some embodiments of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Embodiments of the present disclosure relate to a fusion welding system that allows for the precise measurement of the joining forces being applied, is suitable for environments where combustible gasses may be present and can be quickly deployed in compact excavations and prepared joining sites. In particular, the disclosed principles utilize heated fluid, such as oil, instead of electrical heating, to heat a surface that can be used to contact and transfer heat to a component (e.g., a small diameter pipe) such that a portion of the component melts. More specifically, the heated surfaces of the disclosed system can be a part of a handheld device, which vastly reduces complexity and increases the diversity of environments in which it can be used. The handheld device can include various insulated, high-temperature tubing that receives the heated fluid from an external heating source. The heated fluid can circulate through a plurality of channels within the handheld device, causing flat surfaces of the device to heat up significantly. Then, various components (e.g., a small diameter pipe) can be pressed against the surfaces such that heat is transferred to the component and a portion of the component at least partially melts. Once two components have been partially melted, they can be pressed together until the melted portions cool and re-solidify, thereby creating a joined component.

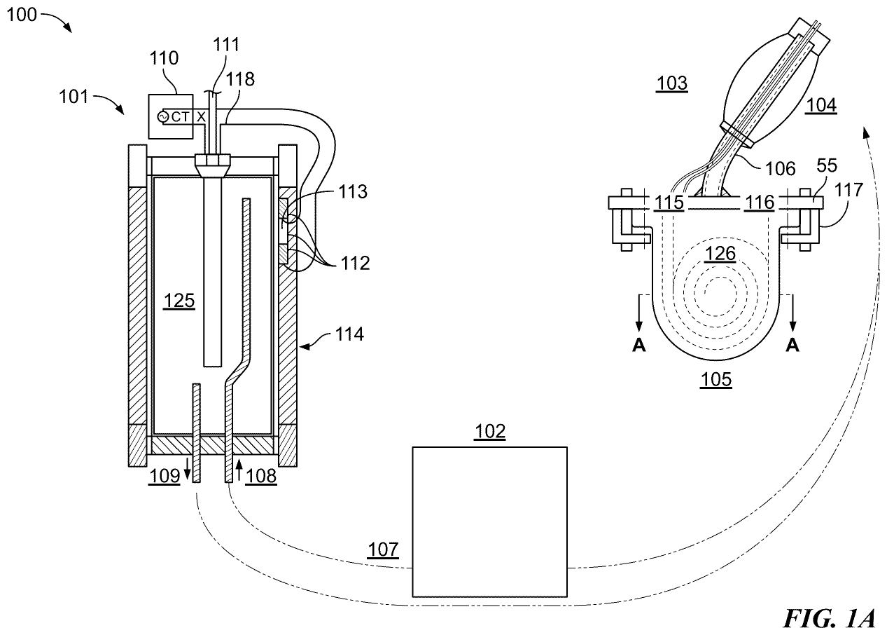

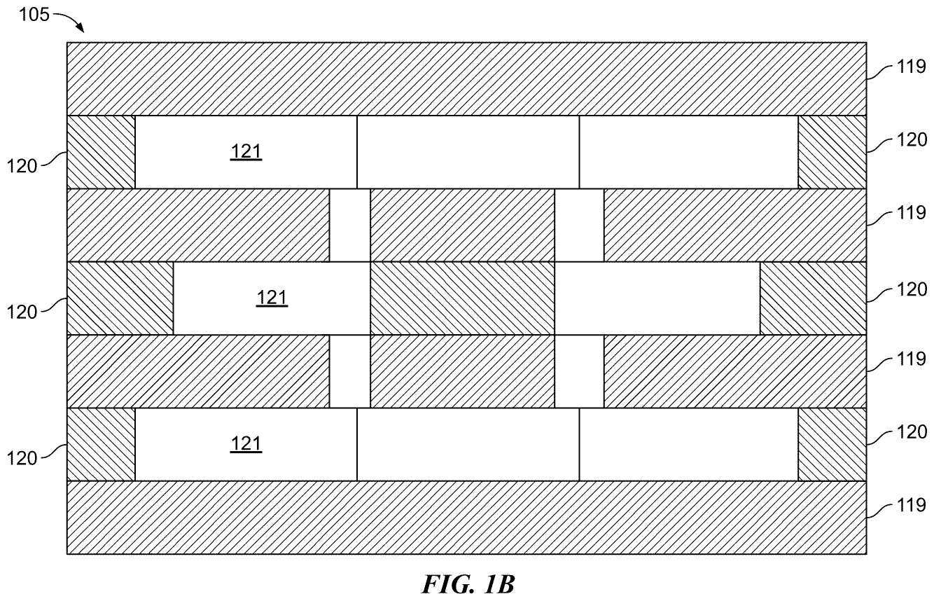

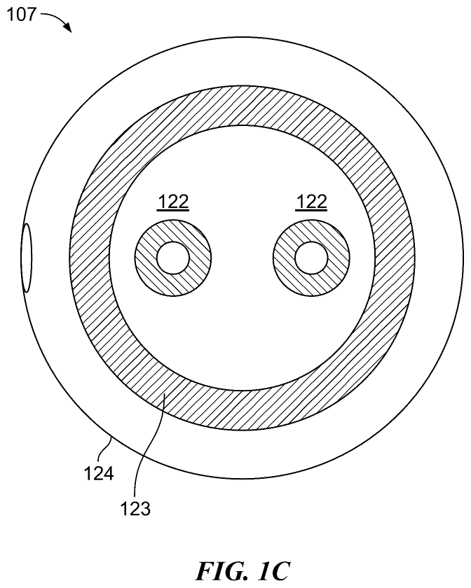

FIGS. 1A-1C show a fusion welding system and its various components according to example embodiments of the present disclosure. In particular, FIG. 1A shows an overview of a fusion welding system 100. The system 100 can include a heating unit 101, a pump 102, and a handheld fusion welding device 103. The heating unit 101 can be configured to heat and maintain a reservoir 125 of fluid, which can be oil. In some embodiments, the fluid can be heated to and maintained at a temperature of approximately 450° F. The pump 102 can pump fluid from the reservoir 125 through high-temperature tubing 107 via an outlet 109. In some embodiments, the pump 102 can be a peristaltic pump. The pump 102 can pump the heated fluid to the handheld fusion welding device 103, where the fluid is circulated within a heating portion 105. Additional details with respect to the heating portion 105 of the handheld fusion welding device 103 are discussed in relation to FIG. 1B. Moreover, the handheld fusion welding device 103 can include an inlet tube and an outlet tube so that the entire system 100 forms a closed loop fluid path. The pump 102 therefore can pump the heated fluid into the handheld fusion welding device 103 via an inlet tube 115, where it circulates through a plurality of channels within the heating portion and eventually exits the handheld fusion welding device 103 via an outlet tube 116. From here, the pump 102 can pump the heated fluid back through the high-temperature tubing 107, into the inlet 108 of the heating unit 101 until it re-enters the reservoir 125.

As the heated fluid is circulated within the heating portion 105 of the handheld fusion welding device 103, a first surface 126 heats up significantly due to the flowing heated fluid. The heating portion 105 can also include a second surface opposite the first surface 126, although it is not visible in FIG. 1A. Once the first surface 126 is heated, a component (e.g., a small-diameter pipe) can be pressed against the surface. Heat is transferred via the contact from the heated fluid circulating within the heating portion 105, which can cause the component to heat up and eventually melt at least partially. In addition, and in some embodiments simultaneously, a second component can be pressed against the second surface (not shown) so that the second component is heated in the same manner. Once the second component has also been melted at least partially, the two components can be manually pressed against each other to fuse the components together.

In some embodiments, the heating unit 101 can also include insulating fiber 114 that surrounds the reservoir 125. In some embodiments, the insulating fiber 114 can be comprised of a ceramic material. In addition, the heating unit 101 can include a sealed, explosion-proof plug 110 for minimizing and/or eliminating explosive risks, a thermostat 111 for monitoring temperature of the fluid within the reservoir 125, a electrical lead 118, high-temperature tape 112, and a thermal fuse 113.

In some embodiments, the high-temperature tubing 107 can include a high-temperature silicon rubber hose.

In some embodiments, the handheld fusion welding device 103 can include a handle 104 and a stainless-steel tube 106. In some embodiments, the handle 104 can include wooden insulation material. In some embodiments, the inlet tube 115 and the outlet tube 116 can be connected to tubing that runs through the handle 104 and is connected to the high temperature tubing 107. In addition, the handheld fusion welding device 103 can include a gasket 117 that thermally isolates and seals the body of the heater from the handle of the heater and isolates the inlet and outlet passages from each other. In some embodiments, the gasket 117 can function similar to a head gasket in an internal combustion chamber, which allows selective passage of fluid from one side of the gasket to the other, while also providing some mechanical stabilization, sealing, and thermal isolation of the handle from the heater body. In some embodiments, the gasket 117 can be rubber or RTV silicone.

FIG. 1B shows a cross-sectional view of the heating portion 105 of the handheld fusion welding device 104 along the line A-A from FIG. 1A. In some embodiments, the heating portion 105 can include various layers of materials that form a high-temperature bonded construction. For example, the heating portion 105 can include layers 119 of glass or laminated glass. In addition, cut glass layers 120 can be placed between other cut or uncut glass layers 119 to form various channels 121. As discussed above in relation to FIG. 1A, the heated fluid can circulate through the channels 121, which allows various components to be heated as they are pressed against the surface of the heating portion 105.

FIG. 1C shows a cross-sectional view of the high-temperature tubing 107. In some embodiments, the tubing 107 can include high-temperature elastomeric tubes 122 (one configured as an inlet feeding fluid to the handheld fusion welding device 103 and the other configured as an outlet returning fluid back to the heating unit 101). In addition, the tubing 107 can include a containment wall 123 and an abrasion jacket 124. In some embodiments, the containment wall 123 can be a high pressure silicon rubber or the like, such as other materials that are able to withstand the temperature of the heating fluid within but not containing the pressure. In some embodiments, an abrasion jacket 124 can be made of thin PVC, woven nylon, or aramid fiber.

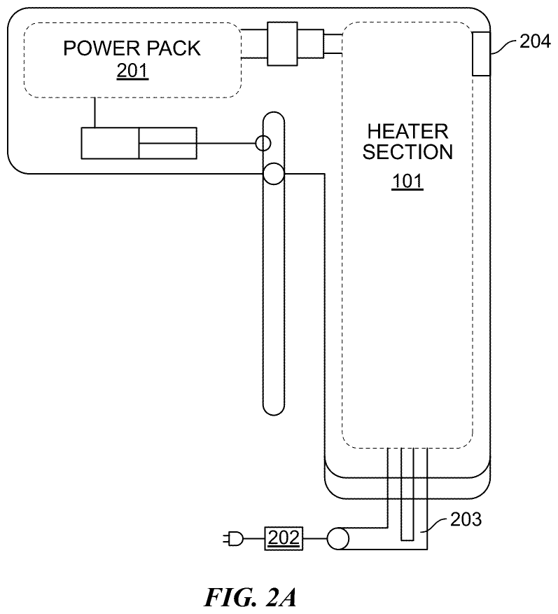

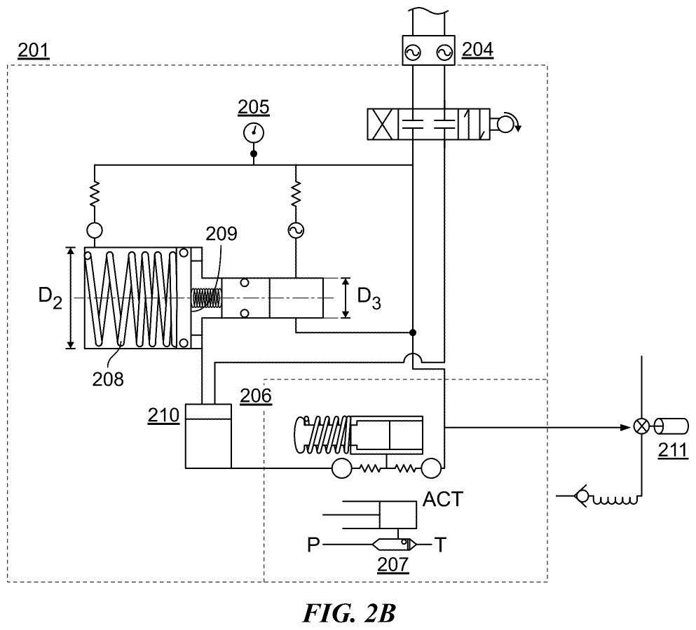

FIGS. 2A-2B show an example power pack according to example embodiments of the present disclosure. More specifically, FIG. 2A illustrates how the power pack 201 is connected to the heating unit 101. In some embodiments, the heating unit 101 is at least partially powered via an electric power source 202 and includes a thermostat 203. In some embodiments, the power pack 201 is configured to provide low volumes of hydraulic fluid at high pressures and higher volumes of hydraulic fluid at lower pressures. the lower volumes of hydraulic fluid at high pressures may be generated manually as shown in the present embodiment exemplar or with a low power electric motor or the like.

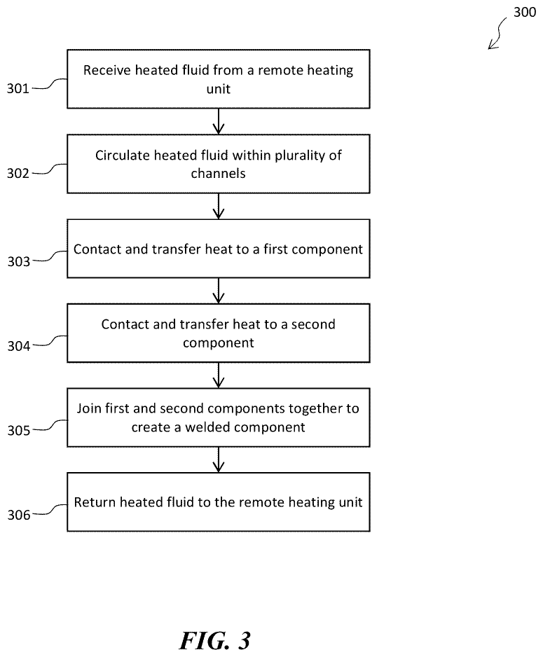

FIG. 3 is a process 300 for operating a fusion welding system according to some embodiments of the present disclosure. In some embodiments, the process 300 can be performed to operate the system 100 of FIG. 1A to fusion weld certain components together, such as plastic small-diameter pipes.

At block 301, the handheld fusion welding device 103 can receive heated fluid (e.g., oil) from the remote heating unit 101. In some embodiments, the heated fluid can be received via an inlet tube 115, where the inlet tube 115 is connected to and receives the heated fluid from a high-temperature tubing 107. In some embodiments, a pump 102 (e.g., a peristaltic pump) can pump the heated fluid that is maintained within a reservoir 125 by the remote heating unit 101. The pump 102 can cause the heated fluid to circulate in a path as described in relation to FIG. 1A. At block 302, after the heated fluid enters the inlet 115 of the handheld fusion welding device 103, the pump 102 circulates the heated fluid within the plurality of channels 121 contained within the heating portion of the handheld fusion welding device 103. In some embodiments, blocks 301 and 302 can be performed continuously so that the heated fluid is constantly flowing through the system.

At block 303, a first surface 126 of the heating portion 105 of the handheld fusion welding device 103 contacts and transfers heat (i.e., from the heated fluid) to a first component, which can be a small-diameter pipe or other similar component, such as molded parts, sheets, profiles, etc. In some embodiments, the component can be comprised of plastic. For example, the component can be held manually and its flat surface (e.g., the flat, circular surface of a cylinder or pipe) can be pressed against the first surface 126. In some embodiments, contacting and transferring heat to the first component can include heating the first component until a portion of the first component melts or at least partially melts, consistent with standard fusion welding requirements. At block 304, a second surface of the heating portion 105 of the handheld fusion welding device 103 contacts and transfers heat to a second component, which can be a small-diameter pipe or other similar component. In some embodiments, both the first and second components can be comprised of the same material. In some embodiments and similar to the heating of the first component, contacting and transferring heat to the second component can include heating the second component until a portion of the second component melts or at least partially melts, consistent with standard fusion welding requirements.

At block 305, the process 300 can include joining the first and second components together to create a welded component. For example, a tool (either mechanical, hydraulic, or electrically powered) can apply the force against the heater and against the other component for the joining portion of the process. In some embodiments, the joining of the components can include hydraulically pressing the components together such that each melted portion contacts each other, and the pressing is performed at an angle consistent with the desired orientation of the final welded component. In some embodiments, the components can be pressed and held together until the melted portions have re-solidified, thereby fusing the components together to create the welded component. At block 306, the pump 102 can return the heated fluid to the remote heating unit 101. In some embodiments, block 306 can, similar to blocks 301 and 302, be performed constantly to ensure fluid is consistently flowing throughout the system.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A handheld fusion welding device comprising:
a handle;
a heating portion attached to the handle and comprising a plurality of channels;
an inlet tube residing within the handle and configured to receive a heated fluid from a remote heating unit and provide the heated fluid to the plurality of channels; and
an outlet tube residing within the handle and configured to receive the heated fluid from the plurality of channels and return the heated fluid to the remote heating unit;
wherein the heating portion comprises a first surface and a second surface opposite the first surface;
wherein the first surface is configured to contact and transfer heat to a first component such that a portion of the first component at least partially melts;
wherein the second surface is configured to contact and transfer heat to a second component such that a portion of the second component at least partially melts;
wherein the at least partially melted portions of the first and second components are joined together to create a welded component.

2. The handheld fusion device of claim 1, wherein the heating portion comprises a plurality of layers of material and the plurality of channels are formed between the layers of the plurality of layers.

3. The handheld fusion device of claim 2, wherein the material comprises at least one of glass or laminated glass.

4. The handheld fusion device of claim 1, wherein the heating portion is clamped to the handle.

5. The handheld fusion device of claim 1, wherein the handle comprises an insulated grip.

6. The handheld fusion device of claim 5, wherein the insulated grip comprises a wood material.

7. The handheld fusion device of claim 1, wherein the heated fluid comprises oil.

8. The handheld fusion device of claim 1, wherein the heated fluid comprises a fluid heated to approximately 450° F.

9. The handheld fusion device of claim 1, wherein the inlet tube and outlet tube comprise a high temperature silicon rubber material.

10. The handheld fusion device of claim 9, wherein the inlet tube and outlet tube are contained within a containment wall and an abrasion jacket surrounding the containment wall.

11. A fusion welding system comprising:
a remote heating unit configured to heat a fluid and maintain the heated fluid;
a handheld fusion welding device; and
a pump configured to pump the heated fluid to the handheld fusion device;
wherein the handheld fusion welding device comprises:
a handle;
a heating portion attached to the handle and comprising a plurality of channels;
an inlet tube residing within the handle and configured to receive a heated fluid from a remote heating unit and provide the heated fluid to the plurality of channels; and
an outlet tube residing within the handle and configured to receive the heated fluid from the plurality of channels and return the heated fluid to the remote heating unit;
wherein the heating portion comprises a first surface and a second surface opposite the first surface;
wherein the first surface is configured to contact and transfer heat to a first component such that a portion of the first component at least partially melts;
wherein the second surface is configured to contact and transfer heat to a second component such that a portion of the second component at least partially melts;
wherein the at least partially melted portions of the first and second components are joined together to create a welded component.

12. The fusion welding system of claim 11, wherein the heating portion comprises a plurality of layers of material and the plurality of channels are formed between the layers of the plurality of layers.

13. The fusion welding system of claim 12, wherein the material comprises at least one of glass or laminated glass.

14. The fusion welding system of claim 11, wherein the heating portion is clamped to the handle.

15. The fusion welding system of claim 11, wherein the handle comprises an insulated grip.

16. The fusion welding system of claim 15, wherein the insulated grip comprises a wood material.

17. The fusion welding system of claim 11, wherein the heated fluid comprises oil.

18. The fusion welding system of claim 11, wherein the heated fluid comprises a fluid heated to approximately 450° F.

19. The fusion welding system of claim 11, wherein the inlet tube and outlet tube comprise a high temperature silicon rubber material.

20. The fusion welding system of claim 19, wherein the inlet tube and outlet tube are contained within a containment wall and an abrasion jacket surrounding the containment wall.
